(19) United States
(12) Patent Application Publication
(10) Pub. No.: US 2021/0341061 A1
(43) Pub. Date: Nov. 4, 2021

(54) Switch Valves for High Pressure Gas

(71) Applicant: INTEROCEAN.CO., LTD, Busan (KR)

(72) Inventors: Jae Ick CHAE, Busan (KR); Hyun Woo JEONG, Gyeongsangnam-do (KR)

(73) Assignee: INTEROCEAN.CO., LTD, Busan (KR)

(21) Appl. No.: 17/040,968

(22) PCT Filed: May 7, 2019
(86) PCT No.: PCT/KR2019/005402

§ 371 Date: Sep. 23, 2020

(30) Foreign Application Priority Data
May 8, 2018 (KR) 10-2018-0052717

(51) Int. Cl. F16K 1/30; F16K 1/02; F16K 1/36; F16K 27/02; F16K 31/50

(52) U.S. Cl. CPC F16K 1/303; F16K 1/02; F16K 31/508; F16K 27/02; F16K 1/36

(57) ABSTRACT

The switch valve for high-pressure gas includes: the flow path through the lower side; the valve body that divaricates and extends towards the upper side of the flow path, and forms a switch with an opening in the upper side; a valve with a long vertical rod shape, the lower side inserted inside the switch, and with a first thread formed on the upper outer side; a handle having the hollow inside and the closed cylindrical upper side, and placed on the upper side of the valve body accommodating the upper side of the valve inside; a second thread corresponding to the first thread and formed on the inner surface of the handle; a valve cover; a pressure scatter hole that through the inside center axis of the handle to connect with the flow path. The gas pressure inside the handle and the flow path is kept in equilibrium.

### CROSS REFERENCE TO THE RELATED APPLICATIONS

This application is the national phase entry of International Application No. PCT/KR2019/005402, filed on May 7, 2019, which is based upon and claims priority to Korean Patent Application No. 10-2018-0052717, filed on May 8, 2018, the entire contents of which are incorporated herein by reference.

### TECHNICAL FIELD

This invention relates to the switch valves for high-pressure gas that is installed on one side of the high-pressure gas receptor, at the junction of the gas pipe line in the high-pressure gas facilities, or at the entrance of a container containing high-pressure gas, and is driven by external forces. In the switch valves regulating the opening and closing of gas, a structure that essentially cancels the forces issued by the difference in pressure on both sides of the switch valves makes it easy to operate the switch valves with little force.

### BACKGROUND

High-pressure gas is compressed gas by high pressure, and under the High-Pressure Gas Safety Control Act, it is compressed gas with a gauge pressure of 10 kgf/cm² or higher at room temperature, with a current pressure of more than 10 kgf/cm², or a pressure of 10 kgf/cm² or higher at a temperature of 35° C. The above high-pressure gas is accommodated in gas pipe lines of high-pressure gas facilities, high-pressure gas container, etc. and is actively applied in various fields of modern industry.

In general, high-pressure receptors, i.e. valves to open and close high-pressure gas which accommodated in the gas pipe lines or high-pressure gas containers, etc., to the outside as necessary are installed. If the valve is coupling with sealing one side of the high-pressure gas receptor, i.e. the junction of the gas pipe line, or the top neck-ring area of the high-pressure gas container, etc., the coupling area will receive both the high pressure inside the receptor and the low pressure on the outside, and the force will be generated in one direction due to the difference in pressure, thus compressing the valve. In this state, the amount of external force that must be applied to the valves for opening one side of the high-pressure receptor is greatly increased by the difference in the pressure above. Therefore, not only the switch operation of the valves is difficult, but the problem was that this process would cause shortening the life expectancy since the wear of coupling area of the valve and the receptor is easily occurred.

In other words, in the past, the valve body, which formed the high-pressure gas flow path, has been fixed to one side of the high-pressure receptor, and it has been operated by switching the high-pressure gas by rotating the handle for switch, and lifting and lowering the valve inserted into the flow path. At this time the internal pressure of the high-pressure gas receptor was directly applied to the coupling area with the above valve, increasing the torque for rotary operation of the handle when opens the valve, making it difficult for the operator to open the valve easily.

In order to solve this, in the Korea Utility Model Registration No. 20-0233081 ‘Open and close valves for fire extinguishing containers’, the technology to operate quickly and smoothly switch valves for fire extinguisher containers, by minimizing the friction area with the inner part of the valve body during operation of switching based on lifting and lowering by forming ‘T’ groove on the switch sides and plugs installed inside the valve body, has been announced. In practice, however, the high pressure in the high pressure tank acted inside the valve, so when opens the valve, the problem of requiring large external forces to operate the handle was not been solved.

In addition, patent No. 10-1748115 of Korea Registration ‘Open and close valve for high-pressure gas’ inserts a spring in a closed cylindrical pace formed between the outer face of the push-type handle and the inner face of the valve body. When closing the vertical switch valves to block gas flow, a person can hold the push-type handle, press the spring down vertically and turn right or left, then the valve locks and blocks the gas flow by sealing X-type double-lip ring. If one wants to open the valve, one can rotate the push-type handle left or right, and the push-type handle automatically moves to its original position by the elastic resilience of the compressed spring to open the valve. The x-type double-lip ring provides excellent gas flow blocking in the axial direction, has high safety of sealed insides, easy operation of switch by springs. Also, compare to the way locked by the screw, this does not operate as a cause of gas leakage by wear particles generated during the tightening process entering to the seal. In addition, the vertical switch valves of the push-tight type with excellent workability were initiated as the switch operation time was greatly reduced by the push-type.

In the preceding technique, although the torque generated at the opening of the valve was easily counterbalanced by the elastic resilience of the spring to facilitate the switch valve, however, the structure was complex and consequently the force exerted by the pressure difference was not fundamentally canceled.

### SUMMARY

The task this invention aims to solve is to minimize torque during operation by preventing the high pressure of high pressure gas from directly acting on the handle driven by external forces, thus providing the switch valves for high pressure gas that can be easily opened and closed with less external force.

Also, it prevents abrasion of the coupling area between the high-pressure gas receptor and the switch valve, which are rubbed according to the rotational operation of the switch valve, so that excellent sealing durability can be maintained even in repeated long-term use, while also extending the life of the switch valve.

The purposes of this invention are not limited to those mentioned above, and other purposes not mentioned may be clearly understood by those with ordinary knowledge in the technical field of this invention as stated here.

To solve the above tasks, the switch valve for high-pressure gas in this invention includes: the flow path through the lower side, the valve body that divaricates and extends towards the upper side of one side of the flow path, but forms switch with open in upper side; a valve with a long vertical rod shape, with the lower side is inserted inside due to the switch, but formed with the first thread on the upper outer side; and a handle that the inside is hollow and the upper side is closed cylindrical type, and it is placed on the upper side of the valve body accommodating the upper side of the valve inside, but second thread corresponding to the first thread is formed on the inner surface; a valve cover that is secured so that the upper face of the valve body and the bottom face of the handle are in contact with each other; the above valves includes a pressure scatter hole through the center axis to connect with the flow path above. The gas pressure from inside of the above handle and the flow path are characterized by keeping in equilibrium.

In addition, the valve protrudes horizontally from the upper outer face towards the outer side and it features an additional tongue formed by the first thread corresponding to the second thread on the protruding cross section.

In addition, the above tongue features a pair formed at each point facing against the center of the horizontal circle of the above valve.

In addition, it features that valve chamber, which is the inside is hollow and the upper side is a closed cylindrical, with the valve inside and the upper part is accommodated inside the handle, and the bottom part is fixed to the upper part with the above switch, but a moving groove is formed by a long vertical penetration on the side wall to guide the movement path of the above tongue, is additionally furnished with.

In addition, it features that this includes the first sealing furnished between the inner side of the above switch and outer side of the above valve, and the second sealing furnished between the upper inner side of the above valve chamber and the upper outer side of the above valve.

Finally, it features the addition of a bearing formed between the bottom side of the above handle and upper side of the above valve body.

According to this invention of above configuration, by preventing high pressure of high-pressure gas from directly acting on the handle driven by external force, torque can be minimized during operation and closed even with a small external force, providing ease of handling.

Also, it prevents abrasion of the coupling area between the high-pressure gas receptor and the switch valves, which are rubbed according to the rotational operation of the switch valve, so that excellent sealing durability can be maintained even in repeated used for a long period of time, thus prolonging life of the switch valve.

### BRIEF DESCRIPTION OF THE DRAWINGS

FIG. 1 is a perspective cross sectional view of the switch valve for high-pressure gas according to the desirable embodiment of this invention.

FIG. 2 is an exploded perspective view of the switch valve for high-pressure gas according to the desirable embodiment of this invention.

FIG. 3 is a cross sectional view in which the flow path of the switch valve for high-pressure gas is closed according to the desirable embodiment of this invention.

FIG. 4 is a cross sectional view in which the flow path of the switch valve for high-pressure gas is open according to the desirable embodiment of this invention.

### DESCRIPTION OF MARK

10: Valve Body
11a: Inlet
11b: Outlet
12: Flow Path
14: Switch
20: Valve
21: Tongue
22: First Thread
24: Pressure Scatter Hole
30: Handle
32: Second Thread
34: Stepped Pulley
40: Valve Chamber
42: Moving Groove
50: Valve Cover
51: Lockout
60: First Sealing
70: Second Sealing
80: Bearing

### DETAILED DESCRIPTION OF THE EMBODIMENTS

The advantages and features of this invention, and how to achieve them, will be clarified by referring to the detailed embodiments with the attached drawings. However, this invention will not be limited to embodiments below, but will be implemented in a variety of different forms. These embodiments are provided only to ensure that the invention is fully initiated and to fully inform the scope of invention to the general knowledgeable person in the technical field to which it belongs. This invention is only defined by the scope of claim.

Refer to the drawings attached below and explain in detail the details for the implementation of this invention. Regardless of the drawing, the same marking number refers to the same component, and “and/or” includes each and every combination of items mentioned.

The terms used here are intended to illustrate embodiments and are not intended to limit this invention. In this statement, the singular form also includes the plural form unless specifically mentioned in the phrase. The “comprises” and/or “comprising” used in this statement do not preclude the presence or addition of one or more other components other than those mentioned.

Unless otherwise defined, all terms (including technical and scientific terms) used in this statement may be used in a sense that can be understood in common to persons with ordinary knowledge in the technical fields to which this invention belongs. In addition, commonly used predefined terms are not ideally or excessively interpreted unless they are explicitly, specifically defined.

The following, referring to the drawings attached hereto, explain in detail the desirable embodiment for this invention.

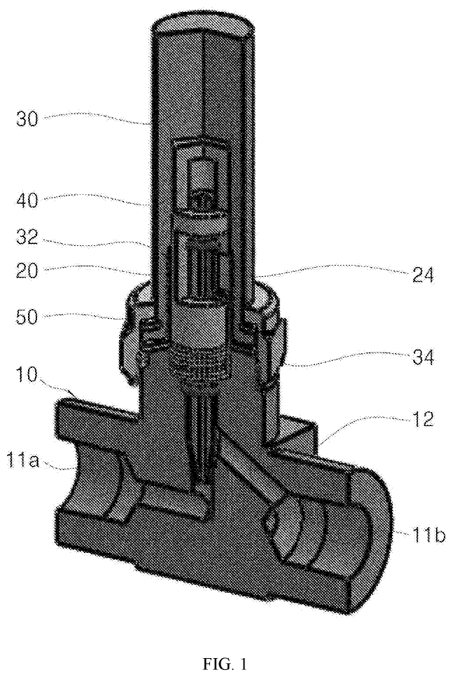

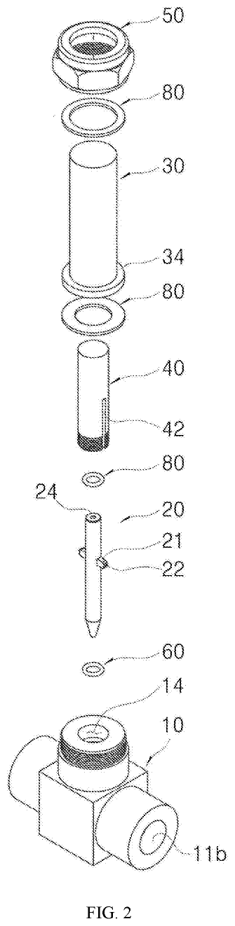

FIG. 1 is a perspective cross sectional view of the switch valve for high-pressure gas according to the desirable embodiment of this invention, and FIG. 2 is an exploded perspective view of the switch valve for high-pressure gas according to the desirable embodiment of this invention.

As illustrated in FIG. 1 and FIG. 2, the switch valve for high-pressure gas include the valve body (10), valve (20), handle (30), valve chamber (40) and valve cover (50).

The valve body (10) is a structure connected to the junction of the gas pipe line, or to the upper neck-ring area of the high-pressure gas container, which forms a flow path by a transverse penetration (12) at the lower part of the valve body (10) so that the above high-pressure gas can be flow inside. The inlet (11a) and outlet (11b) are formed face each other at the one ends and the other ends of the above flow path (12). This means that the high pressure gas from the above high-pressure gas receptor enters the valve body (10) inside through the above inlet (11a), and is ejected outside through the above outlet (11b).

Also, the valve body (10) above forms switches (14) that are ideally branching and extending towards the upper part from the center based on the longitudinal direction, while the upper surface is open at the one side of the flow path (12). The above switch (14) is a space where the lower part of the valve (29) is accommodated, and the branching area from the flow path (12) is switched according to the lifting/lowering the valve (20).

The valve (20) is a lengthwise long rod shape with the lower part inserted inside the switch (14). At this point, the outer surface of the valve (20) forms the first thread (22). The first thread (22) is combined with the second thread (32) formed on the inner surface of the handle (30) to be described later, and switches the flow path (12) by lifting and lowering from the external force that cause rotary motion of the handle (30). The first thread (22) may be applied to the entire outer surface of the valve (20), however, it is preferably formed only in certain areas of the upper part of the outer surface to minimize the occurrence of torque due to friction by reducing the coupling area with the inner surface of handle (30).

For this purpose, the valve body (20) protrudes horizontally towards the outside from the upper outer surface and may additionally be equipped with a tongue (21) with the above first thread (22) formed on the protrusion section. In order words, the above tongue (21) is substantially coupling with handle (30) that is to be described later as a medium for the first thread (22) formed on the protrusion section. The above tongue (21) is formed on the above valve (20), minimizing the coupling area with the above second thread (32) of the handle (30) to reduce the friction resistance during thread coupling motion.

At this point, the above tongue (21) can take various shapes, including the shape of a doughnut extending horizontally along the outer surface of the upper part, and the shape of a bar protruding horizontally at two or more points of an outside line. Most preferably, it is desirable that the tongue shape is formed, but symmetrically formed at the point facing each other related to the center of horizontal circle of the above valve (20). In this case, the external force applied to the above tongue (21) is symmetrically distributed and balanced to prevent the external force from being concentrated in a particular area and broken.

Essentially, the above valve (20) includes a pressure scatter hole (24) through which the center axis is penetrated in connection with the flow path (12) above. This allows the pressure between he flow path (12) and the inside space of the handle (30) which to be described later to remain balanced. The detailed action shall be followed by a detailed description of the handle (30).

In addition, the above valve (20) may be formed to have a smaller diameter from the one side of the lower side to the bottom. The lower side of the above valve (20) is formed in a conical form, and the degree of switch for the flow path (12) can be adjusted in detail according to the diameter change on the flow path (12) when the valve (20) is moved up and down. The lower side of the valve (20) is not limited to this shape since it can be replaced by a disk type, etc., if necessary.

The handle (30) above is a structure that rotates based on the external force exerted by the operator and guides the lifting of the valve (20), which inside is hollow and the upper surface is closed cylindrical type. It is placed on the top of the valve body (10) accommodating the upper part of the valve (20) inside. This means that the upper and lower parts of the valve (20) are accommodated inside, and the handle (30) is placed on the upper part and the valve body (10) is placed on the lower part. At this time, the inner surface of the handle (30) is formed with a second thread (32) corresponding to the first thread (22), and is coupling with the upper part of the valve (20).

These handles (30) are rotated around the center axis by external forces and control the movement of the valve (20) by means of a thread coupling between the first thread (22) and the second thread (32).

In addition, the handle (30) may allow for the formation of stepped pulley (34) that extends horizontally along the lower circumference to increase the area of the bottom surface in contact with the valve body (10). As the above stepped pulley (34) is formed, the above handle (30) is stably coupling with the valve cover (50), which shall be described in detail in the valve cover (50).

Valve cover (50) is a close coupling of the valve body (10) and the handle (30) to allow the handle (30) to rotate without vertical movement at the top of the valve body (10).

The handle (30) and the valve body (10) are coupling with together with the lower part of the handle (30) and the upper part of the valve body (10) inserted in the upper and lower inner surfaces respectively in a nut or flange shape as a whole.

In more detail, the valve cover (50) is shaped like a hollow nut, and at the top, a lockout (51) is formed that is flexed towards the inside to secure the above stepped pulley (34), which is extended horizontally from the bottom part of the handle (20). The lower inner surface forms a thread corresponding to the thread formed on the upper outer surface of the valve body (10).

This ensures that the bottom of the handle (20) and the top of the valve body (10) are in contact with each other by the above lockout (51) latches the above stepped pulley (34) and coupling with the above valve body from the bottom part. At this time, in order to minimize the friction by the contact on the handle (20) which rotates internally without any room left in the top and bottom, the material between the upper part of stepped pulley (34) and the bottom part of the lockout (51), and the bottom part of the stepped pulley (34) and the upper part of the valve boy (10) can be formed as a free material for friction. Ideally, a bearing (80) may be formed in the area to mechanically cancel the friction.

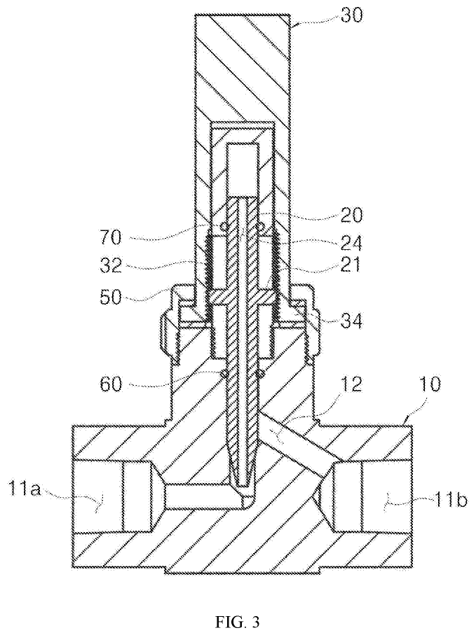

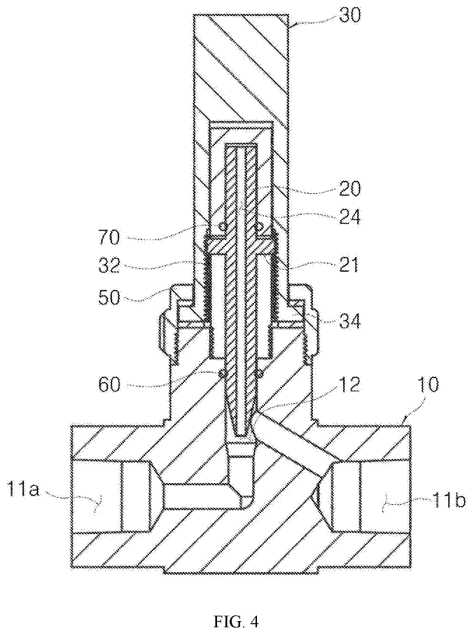

FIG. 3 is a cross sectional view in which the flow path of the switch valve for high-pressure gas is closed according to the desirable embodiment of this invention, and FIG. 4 is a cross sectional view in which the flow path of the switch valve for high-pressure gas is open according to the desirable embodiment of this invention.

Refer to FIG. 3 and FIG. 4 to explain embodiments of switch valves for high-pressure gas of this invention, including the above-mentioned components; it controls the switch of high-pressure gas by switching the flow of the flow path (12) with the lower part of the valve (20) inserted into the switch (14).

Basically, according to the rotational movement of the handle (30), The valve (20) is driven up and down by a screw coupling between the second thread (32) formed on the inner surface of the handle (30) and the first thread (22) formed at the end of the tongue (21) of the valve (20).

For the description of the principle of minimizing torque applied to the handle (30), the most important task of this invention, through the structural features of the above components, first of all, the pressure applied from the flow path (12) around the inlet (11a) to the valve (20) is distributed to the inner space of the handle through the above pressure scatter hole (24), and the valve (24) has a structure in which no high pressure is concentrated. Then, the pressure may be applied to the handle (30), which is physically fixed with the valve body (10) by the valve cover (50), so the area where the pressure is concentrated will, in effect, be the coupling area of the valve cover (50), handle (30) and the valve body (10). However, the coupling area is closely fixed so that there is no up/down movement, and either a material that can minimize friction is applied or a bearing (80) is included, so the pressure caused by the gas pressure is canceled and torque is minimized.

The above components alone will address the purpose of this invention, but the switch valve for high-pressure gas may additionally include the valve chamber (40) in order to maximize the rotational motion efficiency of the handle (30) by distributing the above gas pressure more efficiently and preventing idle of the valve (20) at the same time.

The valve chamber (40) is hollowed inside, and cylindrical type with the upper surface is closed. The valve (20) is accommodated inside, but blocks the idle of the valve (20) by guiding the vertical travel path of the above tongue (21) through forming a moving groove to provide a space for up/down movements with a tongue (21) inserted vertically from the side wall. Also, the lower part is kept confidential with the upper switch (14) and secured to be connected, while the upper part is accommodated inside the handle (30). To prevent the gas pressure applied from the flow path (12) from spreading inside the handle (30), a closed compartment is provided, and the pressure applied to the handle (30) is systematically blocked, dramatically reducing the amount of the force required to operate the handle (30).

In more detail, the valve chamber (40) is coupling with thread formed on the upper inner surface of the switch (14) of the valve body (10) as illustrated in the drawings; a thread is formed on the lower outer surface with the valve (20) accommodated inside. The upper part is accommodated inside the handle (30) with the top surface is closed. For the path of the gas pressure applied to the switch valve as the valve chamber (40) is additionally furnished, the gas pressure generated by the high pressure gas accommodated in the flow path (12) is distributed through the pressure scatter hole (24) of the valve (20), into the upper inner space of the valve chamber (40), and pressure is applied to the valve chamber (40). However, since the valve chamber (40) is coupling with the valve body (10) above, so the pressure is concentrated on the thread coupling area which formed on the threads on the lower outer surface of the valve chamber (40) and on the upper inner surface of the switch of the valve body (10), and it does not disturbed to the above handle (30). This provides a pressure-free structure for the valve (20) and handles (30), and significantly reducing the amount of external force required to rotate the handle (30).

In order to prevent gas pressure from leaking out of the valve chamber (40), the first and second sealing (60, 70) is formed. The first sealing (60) is located between the lower inner surface of the switch (14) (i.e. the lower part based on the thread area coupling with the valve chamber (40)) and the outer surface of the valve. The second sealing (70) is located between the upper inner surface of the valve chamber (40) (i.e. the upper part based on the area where the above moving groove is formed) and the upper outer surface of the valve (20).

To further explain the action of the coupling between the moving groove (42) of the valve chamber (40) and the tongue (21) of the valve (20), the above tongue (21) is inserted into the above moving groove (42) and coupling with the above handle (30) by the first thread (22) and the second thread (32), so that no idle movement occurs as the handle (30) rotates around the center axis, and only the lifting and lowering motion is performed along the moving groove (42). This prevents problems such as operation trouble, etc. due to idle of the valve (20).

Although the embodiments of this invention have been described by reference to the drawings accompanying this invention, those with general knowledge in the technical field to which it belongs will be able to understand that the invention can be carried out in other specific forms without changing its technical ideas or essential features. Thus, the embodiments described above should be understood to be illustrated and non-limited in all respect.

What is claimed is:

1. A switch valve for high-pressure gas, comprising:
a flow path through a lower side of the switch valve;
a valve body, wherein the valve body divaricates and extends towards an upper side of one side of the flow path, and forms a switch with an opening in the upper side of one side of the flow path;
a valve with a long vertical rod shape, wherein a lower side of the valve is inserted inside the valve body through the switch, and a first thread is formed on an upper outer side of the valve;
a handle, wherein an inside of the handle is hollow and an upper side of the handle is closed cylindrical type, and the handle is placed on an upper side of the valve body accommodating an upper side of the valve inside, and a second thread corresponding to the first thread is formed on an inner surface of the handle;
a valve cover, wherein the valve cover is secured to ensure that an upper face of the valve body and a bottom face of the handle are in contact with each other; and
a pressure scatter hole inside the handle, wherein the pressure scatter hole through a center axis of the inside of the handle connects with the flow path of the lower side of the switch valve, and a gas pressure from the inside of the handle to the flow path are kept in equilibrium.

2. The switch valve for high-pressure gas according to claim 1, wherein
the valve comprises a tongue formed by the first thread corresponding to the second thread, and the tongue protrudes horizontally from the upper outer side of the valve.

3. The switch valve for high-pressure gas according to claim 2, wherein
the valve further comprises a pair of the tongue, wherein the pair of the tongue are formed symmetrically on the valve.

4. The switch valve for high-pressure gas according to claim 3, further comprising
a valve chamber, wherein an inside of the valve chamber is hollow and an upper side of the valve chamber is a closed cylindrical, the valve is arranged inside the valve chamber, an upper part of the valve chamber is accommodated inside the handle, and a bottom part of the valve chamber is fixed to an upper part of the switch; and
a pair of a moving groove, wherein the moving groove is formed by a long vertical penetration on a side wall of the valve chamber to guide a movement path of the tongue into the valve chamber.

5. The switch valve for high-pressure gas according to claim 4, further comprising
a first sealing furnished between an inner side of the switch and the outer side of the valve; and
a second sealing furnished between an upper inner side of the valve chamber and the upper outer side of the valve.

6. The switch valve for high-pressure gas according to claim 1, further comprising
a bearing formed between the bottom face of the handle and the upper face of the valve body.
